(19) United States
(12) Patent Application Publication
(10) Pub. No.: US 2014/0157147 A1
(43) Pub. Date: Jun. 5, 2014

(54) FEEDBACK SYSTEM, FEEDBACK METHOD AND RECORDING MEDIA THEREOF

(71) Applicant: INSTITUTE FOR INFORMATION INDUSTRY, Taipei (TW)

(72) Inventors: Ren-Dar YANG, Hsinchu City (TW); Hung-Sheng CHIU, New Taipei City (TW); Tse-Ming TSAI, Taipei City (TW); Shih-Chun CHOU, Taipei City (TW); Bo-Fu LIU, Tainan City (TW); Jih-Yiing LIN, Zhuqi Township (TW); Pei JIANG, Zhudong Township (TW); Yu-Ting LIN, Chiayi City (TW); Hsiao-Chen CHANG, Taipei City (TW)

(21) Appl. No.: 13/908,404

(22) Filed: Jun. 3, 2013

(30) Foreign Application Priority Data
Dec. 4, 2012 (TW) 101145389

(51) Int. Cl. G06F 3/0484

(52) U.S. Cl. CPC G06F 3/04842
USPC 715/751

(57) ABSTRACT

The present invention discloses a feedback system. The feedback system includes an application executing module, a trigger module and a feedback interface module. The application executing module executes an application to display a plurality of display elements, wherein at least one of the display elements corresponds to at least one of a plurality of motion events provided for users to operate. The trigger module receives a first selection signal when the application executing module executes the application, wherein the first selection signal corresponds to an indicated feedback element, and the indicated feedback element is one of the display elements. The feedback interface module receives a first feedback content corresponding to the indicated feedback element and generates a first feedback message, when the trigger module receives the first selection signal, wherein the first feedback message includes the first feedback content and the first selection signal.

### CROSS REFERENCE TO RELATED APPLICATIONS

This Application claims priority of Taiwan Patent Application No. 101145389, filed on Dec. 4, 2012, the entirety of which is incorporated by reference herein.

### BACKGROUND OF THE INVENTION

1. Field of the Invention

The present invention relates to a feedback system, a feedback method and a recording media, and in particular relates to a feedback system, a feedback method and a recording media used to feedback comments for an executed application.

2. Description of the Related Art

Presently, mobile devices are highly developed and multi-functional. For example, handheld devices, such as mobile phones or tablets, are capable of telecommunications, receiving/transmitting e-mails, linking to social networks, and playing media, etc. Hence, users can get various services by the applications (such as mobile APP) on their mobile devices like communications, games, e-books, magazines, etc., according to their needs.

However, the applications applied to the mobile devices are more complicated than the applications applied to the general computers due to the various sensing devices on the mobile devices which can be integrated with the applications for inputting or outing, such as accelerometers, electronic gyroscopes or touch screens, etc. Therefore, the application development tools, web development tools and the image edition tools of the general computers are not suitable for the applications applied to the mobile devices. Moreover, the specifications and sensing devices of the mobile devices are not the same. Therefore, more than one application programs for different mobile devices are needed, and the developments need to be finished quickly and exactly. But, during the development, the comments of the art editors, managers, and users, etc. are needed to adjust and finalize the application. However, there is no suitable feedback system to provide the draft applications to art editors, managers, and users, etc., and receive their comments for adjusting and finalizing the applications. Therefore, the development process is inconvenience for developers.

### BRIEF SUMMARY OF THE INVENTION

A detailed description is given in the following embodiments with reference to the accompanying drawings. The feedback system provided by the present invention can be used to feedback comments for an executed application and the display elements of the executed application for users, and can generate feedback messages accordingly in order to transmit to a server. The display elements of the executed application correspond to a plurality of motion events which are provided for users to operate. The users can browse and operate the display elements displayed by the application, and provide the feedback messages to the server for the display elements and the operations. Furthermore, the server disclosed by the present invention is used to transmit the feedback messages to the corresponding developers.

The present invention discloses a feedback system used to feedback comments for an application when the application is being executed. The feedback system includes an application executing module, a trigger module, a feedback interface module and a transmission module. The application executing module is used to execute the application to display a plurality of display elements, wherein at least one of the display elements corresponds to at least one of a plurality of motion events provided for users to operate. The trigger module is used to receive a first selection signal when the application executing module executes the application, wherein the first selection signal corresponds to an indicated feedback element, and the indicated feedback element is one of the display elements. The feedback interface module is used to receive a first feedback content corresponding to the indicated feedback element and generate a first feedback message, when the trigger module receives the first selection signal, wherein the first feedback message includes the first feedback content and the first selection signal. The transmission module is used to transmit the first feedback message to a server.

Additionally, the present invention further discloses a feedback method applied to a feedback system and used to feedback comments for an application when the application is being executed. The feedback method includes: executing the application to display a plurality of display elements, wherein at least one of the display elements corresponds to at least one of a plurality of motion events provided for users to operate; determining whether a first selection signal has been received when the application is being executed; receiving a first feedback content corresponding to an indicated feedback element when the first selection signal has been received, wherein the indicated feedback element is one of the display elements; generating a first feedback message, wherein the first feedback message includes the first feedback content and the first selection signal; and transmitting the first feedback message to a server.

Furthermore, the present invention discloses a recording media used to store a plurality of physical computer readable codes used for retrieval and execution by computers for a feedback method. The recording media includes a first program code, a second program code, a third program code, a fourth program code and a fifth program code. The first program code is used to execute an application to display a plurality of display elements, wherein at least one of the display elements corresponds to at least one of a plurality of motion events provided for users to operate. The second program code is used to determine whether a first selection signal has been received when the application is being executed. The third program code is used to receive a first feedback content corresponding to an indicated feedback element when the first selection signal has been received, wherein the indicated feedback element is one of the display elements. The fourth program code is used to generate a first feedback message, wherein the first feedback message includes the first feedback content and the first selection signal. The fifth program code is used to transmit the first feedback message to a server.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of a feedback system of the present invention;

FIG. 2 is a schematic diagram illustrating an embodiment of an electronic device of the present invention;

FIG. 3 is a schematic diagram illustrating an embodiment of a server of the present invention;

FIG. 4 is a flowchart of a feedback method according to an embodiment of the present invention.

FIG. 5 is a flowchart of a feedback method according to another embodiment of the present invention.

FIG. 6A-6B are a flowchart of a feedback method according to another embodiment of the present invention.

FIG. 7 is a flowchart of a feedback method according to another embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

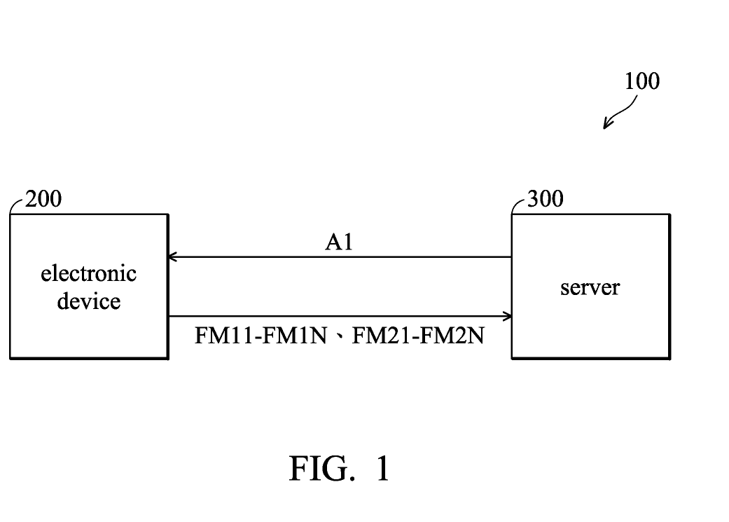

FIG. 1 is a schematic diagram illustrating an embodiment of a feedback system of the present invention. The feedback system 100 can be applied to an electronic device 200. The electronic device 200 connects with a server 300 by networks. For example, the electronic device 200 can connect with the server 300 by a Local area network (LAN), intranet, Internet network, Radio telecommunications network) or Public switched network, but it is not limited thereto. The server 300 is used to develop an application A1, and to provide the application A1 to the electronic device 200. The electronic device 200 is used to execute the application A1 and transmit at least one first feedback message(s) FM11-FM1N and/or at least one second feedback message(s) FM21-FM2N to the server 300.

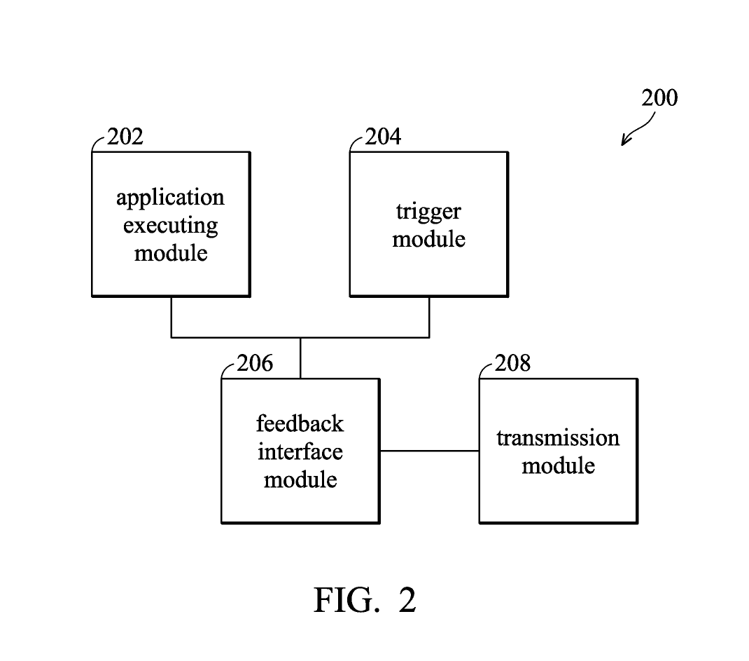

FIG. 2 is a schematic diagram illustrating an embodiment of an electronic device of the present invention. The electronic device 200, such as a smart phone, tablet PC, notebook or other, includes an application executing module 202, a trigger module 204, a feedback interface module 206 and a transmission module 208. Moreover, those skilled in the art will understand that some embodiments of the electronic device 200 may be practiced with other computer system configurations, such as hand-held devices, multiprocessor-based system, microprocessor-based system, PCs, network PCs, minicomputers, mainframe computers, and the like. For example, the electronic device 200 can include a processing unit (not shown) and a memory unit (not shown), wherein the processing unit and the memory unit can be connected by buses. In some embodiments, the electronic device 200 can further include identification devices, registers, memory units, applications and operating systems, etc. Moreover, those skilled in the art will understand that some embodiments may be practiced with other electronic devices configurations, such as hand-held devices, portable devices, personal digital assistant, multiprocessor-based, microprocessor-based or programmable consumer electronics, and the like. The processing unit can include a central-processing unit (CPU) or a plurality of processing units related to a parallel processing environment. The memory unit can be read only memories (ROM), flash ROMs and/or random access memories (RAM) for storing program codes executed by the processing unit. Generally, program codes can be routines, programs, objects, components or Web Services, etc.

The application executing module 202 is used to execute the application A1 to display a plurality of display elements, wherein the application includes at least one of the display elements and at least one of a plurality of motion events provided for users to operate. More specifically, each of the display elements corresponds to a display element code, respectively. Each of the motion events corresponds to a motion event code, respectively. The display elements, the corresponding display element codes, the motion events, and the corresponding motion event codes can be recorded in a table or a file stored in the memory unit or hard disk of electronic device 200. For example, when one of the display elements displayed by the application A1 is selected, one of the motion events is to scale up the selected display element. Moreover, when the other one of the display elements displayed by the application A1 receives a switching instruction, one of the motion events is to change the display frame on the application A1. Furthermore, when another one of the display elements displayed by the application A1 receives an adjusting instruction, one of the motion events is to display adjusting interface. But it is not limited thereto. It should be noted that each of the display elements can be set with a predetermined position and a color setting information corresponding to its display element code respectively, wherein the color setting information of the display elements is used to set the color of the display elements for display. The color of the display elements can be a single color, multi-colored, a gradient color, or a special textured color, such as wood grain, marble, sky, etc. For example, the background of the application A1 can be one of the display elements. Moreover, the images shown in the application A1 can also be the display elements, but it is not limited thereto.

The trigger module 204 is used to receive a first selection signal corresponding to an indicated feedback element when the application executing module 202 executes the application A1. It should be noted that the indicated feedback element is one of the display elements. Moreover, the first selection signal can indicate a motion event by the motion event code corresponding to the indicated feedback element by the display element code. More specially, the trigger module 204 is used to receive a second selection signal when the application A1 is being executed. The second selection signal can be used as setting information corresponding to the indicated feedback element by the display element code. In another embodiment, the trigger module 204 is further used to receive a trigger signal and a completion signal. The trigger signal is used to enable the feedback interface module 206 to feedback for the motion events and the display elements. The completion signal is used to disable the feedback interface module 206 to feedback about the motion events and the display elements.

In some embodiments, when the trigger module 204 receives a first trigger signal, the electronic device 200 starts the trigger module 204 to be ready to receive the first selection signal(s) corresponding to the motion event(s), and it is in a first feedback period. The first feedback period ends when the trigger module 204 receives a completion signal. Namely, the first feedback period is the time between the first trigger signal and the completion signal received by the trigger module 204. In another embodiment, the electronic device 200 is further used to determine whether the trigger module 204 is in a second feedback period for receiving the second selection signal(s) corresponding to the display element(s). For example, when the trigger module 204 receives the first trigger signal, it is in the first feedback period. That means, the electronic device 200 starts the trigger module 204 to be ready to receive the first selection signal corresponding to the motion events. When the trigger module 204 receives a second trigger signal, the first feedback period ends, and the second feedback period starts. The electronic device 200 starts the trigger module 204 to be ready to receive the second selection signal(s) corresponding to the display element(s) until the trigger module 204 receives a completion signal. The second feedback period ends when the trigger module 204 receives the completion signal. Namely, the time between the first trigger signal and the second trigger signal received by the trigger module 204 is the first feedback period, and the time between the second trigger signal and the completion signal received by the trigger module 204 is the second feedback period, but it is not limited thereto. In another embodiment, when the trigger module 204 receives the first trigger signal, it is in the first feedback period. The electronic device 200 starts the trigger module 204 to be ready to receive the first selection signal corresponding to the motion event. When the trigger module 204 receives a first completion signal, the first feedback period ends. When the trigger module 204 receives the second trigger signal, it is in the second feedback period. The electronic device 200 starts the trigger module 204 to be ready to receive the second selection signal(s) corresponding to the display element(s). The second feedback period ends when the trigger module 204 receives a second completion signal during the second feedback period. Namely, the time between the first trigger signal and the first completion signal received by the trigger module 204 is the first feedback period, and the time between the second trigger signal and the second completion signal received by the trigger module 204 is the second feedback period. It should be noted that the terminology, first and second feedback periods, are used to indicate difference periods, and do not represent that the first feedback period is before the second feedback periods. Namely, the second feedback period can be prior to the first feedback period, but it is not limited thereto.

The feedback interface module 206 is used to receive a first feedback content corresponding to the indicated feedback element and generate a first feedback message FM11 when the trigger module 204 receives the first selection signal, wherein the first feedback content is an indicated motion event corresponding to the indicated feedback element, and the first feedback message FM11 includes the first feedback content and the first selection signal. In another embodiment, the motion event code corresponding to the motion event of the first selection signal is the motion event code corresponding to the last executed motion event, but it is not limited thereto. It should be noted that, in the other embodiments of the present invention, the feedback interface module 206 is further used to generate a plurality of first feedback messages FM11-FM1N according to a plurality of first selection signals and a plurality of first feedback contents. In another embodiment, the feedback interface module 206 is used to receive a second feedback content corresponding to the indicated feedback element and generate a second feedback message FM21 when the trigger module 204 receives the second selection signal, wherein the second feedback content is display setting information corresponding to the indicated feedback element, and the second feedback message includes the second feedback content and the second selection signal. In another embodiment, the feedback interface module 206 is further used to receive a second feedback content corresponding to the indicated feedback element and integrate the second feedback content into the first feedback message FM11, when the trigger module 204 receives the second selection signal. It should be noted that the terminology, first and second selection signals, are used to indicate difference selection signals, and do not represent that the selection signal is received before the second selection signals. Namely, the receiving priority of the first selection signal and the second selection signal by the feedback interface module 206 is not limited in the present invention. It should be noted that, in the other embodiments of the present invention, the feedback interface module 206 can generate a plurality of first feedback messages FM11-FM1N according to a plurality of first selection signals and a plurality of first feedback contents in the first feedback period and generate a plurality of second feedback messages FM21-FM2N according to a plurality of second selection signals and a plurality of second feedback contents in the second feedback period, respectively. In another embodiment, the feedback interface module 206 can generate a plurality of first feedback messages FM11-FM1N according to a plurality of first selection signals and a plurality of first feedback contents in the first feedback period and write a plurality of second feedback contents into the first feedback messages FM11-FM1N according to a plurality of second selection signals and the second feedback contents in the second feedback period, respectively. Moreover, in another embodiment, the first feedback message(s) FM11-FM1N and the second feedback message(s) FM21-FM2N can include the identification code of the electronic device 200, but it is not limited thereto.

In some embodiments of the present invention, the application A1 can display the display elements by an application interface. In some embodiments of the present invention, the feedback interface module 206 is further used to generate a feedback interface and display the feedback interface above the application interface of the application A1. Furthermore, the trigger module 204 can receive the first selection signal, the second selection signal and the completion signal by the application interface and the feedback interface. Namely, when the electronic device 200 executes the application A1, the electronic device 200 can display the display elements of the application A1 by the application interface to provide users with browsing operations and for operation. When users want to feedback something about the display element(s) and the motion event(s), the feedback interface module 206 can generate the feedback interface and display the feedback interface on the application interface, such that users can operate the feedback interface to generate the first selection signal(s) and input the first feedback content(s) corresponding to the display element(s). The feedback interface module 206 will be described further with details as following.

The feedback interface module 206 can receive the first feedback content and the second feedback content by the application interface and the feedback interface according to the first selection signal or the second selection signal. The feedback interface module 206 is further used to provide a voice recording interface, a video recording interface, a text input interface, a drawing interface or a screenshot figure interface to generate the first feedback content and the second feedback content according to the first selection signal or the second selection signal. Namely, when the trigger module 204 receives the first selection signal or the second selection signal, the feedback interface module 206 provides a voice recording interface, a video recording interface, a text input interface, a drawing interface or a screenshot figure interface to generate the first feedback content and the second feedback content. For example, users can input a first trigger signal and/or a second trigger signal through the feedback interface to start the first feedback period or the second feedback period when users want to provide comments about the motion events and/or the display elements.

For example, in the first feedback period, users can operate the application A1 continuously until users operate the motion event they want to feedback to the developer, and users input a first selection signal through the feedback interface provided by the feedback interface module 206. Next, users can input comments through a voice recording interface, a video recording interface, a text input interface, a drawing interface or a screenshot figure interface provided by the feedback interface to generate a first feedback content. Namely, the first feedback content can be a recording file, an image, a text file or an image file. Next, the feedback interface module 206 generate a first feedback message FM11 according to the first feedback content and the motion event code corresponding to the last motion event executed by the application executing module 202, but it is not limited thereto.

In the second feedback period, users can directly select the display element which they want to feedback to generate a second selection signal. Next, users can input comments through a voice recording interface, a video recording interface, a text input interface, a drawing interface or a screenshot figure interface provided by the feedback interface to generate a second feedback content. Namely, the second feedback content can be a recording file, an image, a text file or an image file. Next, the feedback interface module 206 generate a second feedback message FM21 according to the second feedback content and the display element code corresponding to the selected display element, but it is not limited thereto.

The transmission module 208 is used to transmit at least one of first feedback message(s) FM11-FM1N and/or at least one of second feedback message(s) FM21-FM2N to a server 300. For example, when the feedback interface module 206 generates one of the first feedback message FM11-FM1N and/or the second feedback message FM21-FM2N, the transmission module 208 transmits the one of the first feedback message FM11-FM1N and/or the second feedback message FM21-FM2N to the server 300, synchronously, but it is not limited thereto. In another embodiment of the present invention, the transmission module 208 can transmit the at least one of the first feedback message(s) FM11-FM1N to the server 300, simultaneously, when the first feedback period ends, and transmit the at least one of the second feedback message(s) FM21-FM2N to the server 300, simultaneously, when the second feedback period ends. In yet another embodiment, the transmission module 208 can transmit the at least one of the first feedback message(s) FM11-FM1N and the at least one of the second feedback message(s) FM21-FM2N to the server 300, simultaneously, when the second feedback period ends.

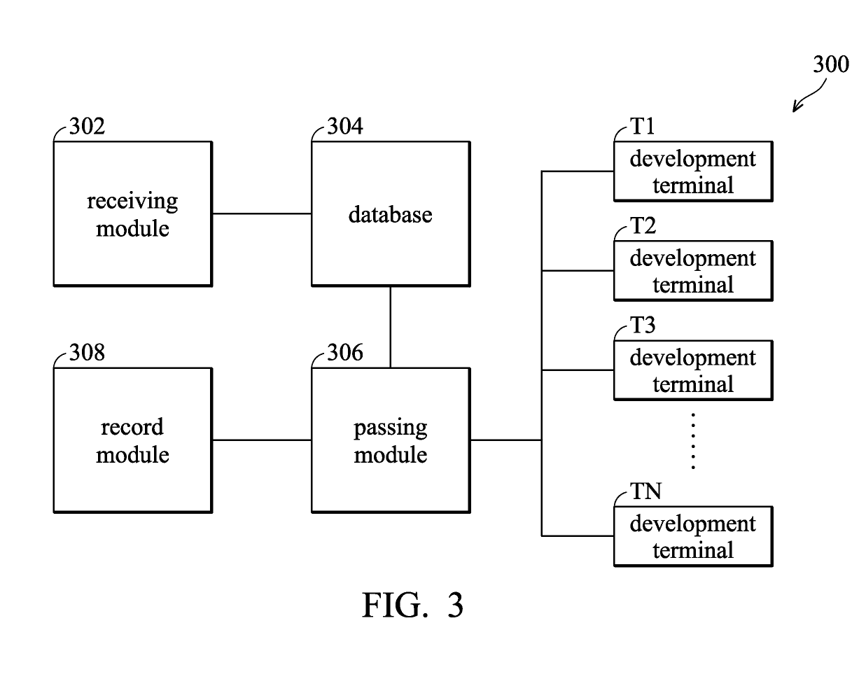

Moreover, the feedback system further includes the server 300. FIG. 3 is a schematic diagram illustrating an embodiment of a server of the present invention. The server 300 includes a receiving module 302, a database 304, a passing module 306, a record module 308 and a plurality of development terminals T1-TN. The server 300 can include a processing unit (not shown) and a memory unit (not shown), wherein the processing unit and the memory unit can be connected by buses. In some embodiments, the electronic device 200 can further include identification devices, registers, memory units, applications and operating systems, etc. The processing unit can include a central-processing unit (CPU) or a plurality of processing units related to a parallel processing environment. The memory unit can be read only memories (ROM), flash ROMs and/or random access memories (RAM) for storing program codes executed by the processing unit. Generally, program codes can be routines, programs, objects, components or Web Services, etc.

The receiving module 302 is used to receive the first feedback message(s) FM1-FM1N and/or the second feedback message(s) FM21-FM2N from the electronic device 200 and transmit the first feedback message(s) FM1-FM1N and/or the second feedback message(s) FM21-FM2N to the database 304 for storing.

The database 304 is used to store a record table, the received first feedback message(s) and the received second feedback message(s), wherein the record table is used to store the information of the development terminals corresponding to the display elements or the motion events.

The passing module 306 is used to transmit the first feedback message(s) FM1-FM1N and the second feedback message(s) FM21-FM2N to the development terminal(s) corresponding to the indicated feedback element according to data of the record table and the first feedback message(s) FM1-FM1N and the second feedback message(s) FM21-FM2N which correspond to the indicated feedback element.

The record module 308 is used to record the development terminals corresponding to each of the motion events and each of the display elements in the record table. The passing module 306 is used to transmit the first feedback message(s) FM1-FM1N and the second feedback message(s) FM21-FM2N to the corresponding development terminal(s) according to the record table recorded by the record module 308. For example, each of the display elements corresponds to a display element code respectively, and each of the motion events corresponds to a motion event code respectively. Each of the development terminals corresponds to information of a developer, and the record table is used to record the relation of each of the display elements, each of the motion events, and the information of the corresponding developers. The passing module 306 is further used to retrieve the corresponding information of a developer corresponding to the display element code and the motion event code of the indicated feedback element from the record table and transmit the first feedback message or the second feedback message. It should be noted that the record module 308 can divide the interface of the application A1 into a plurality of areas, and record each of the display elements and the display elements with the corresponding development terminals by tree data.

For example, the interface of the application A1 developed by the server 300 can be divided into a plurality of areas, wherein a first area of the areas is compiled by a development terminal T1, a second area of the areas is compiled by a development terminal T2 and a third area of the areas is compiled by a development terminal T3, but it is not limited thereto. The first area includes a first motion event and a second motion event. The second area includes a first display element and a second display element. The third area includes a third motion event, a fourth motion event and a third display element. When the receiving module 302 receives the first feedback message FM11 including a motion event code corresponding to the third motion event, the passing module 306 determines that the first feedback message FM11 is corresponding to the third area according to the information of the record module 308, and transmits the first feedback message FM11 to the development terminal T3. When the receiving module 302 receives the second feedback message FM21 including the display element code corresponding to the first display element, the passing module 306 determines that the second feedback message FM21 is corresponding to the second area according to the information of the record module 308, and transmits the second feedback message FM21 to the development terminal T2, but it is not limited thereto.

In another embodiment of the present invention, the first feedback content includes at least one first instruction used for adjusting the motion of the motion event corresponding to the indicated feedback element. The second feedback content includes at least one second instruction used for adjusting the predetermined position and the color setting information of the display element corresponding to the indicated feedback element. In another embodiment, the server 300 further includes an application adjusting module (not shown) used to modify the corresponding indicated feedback element of the application A1 according to the first instruction and/or the second instruction to update the application A1.

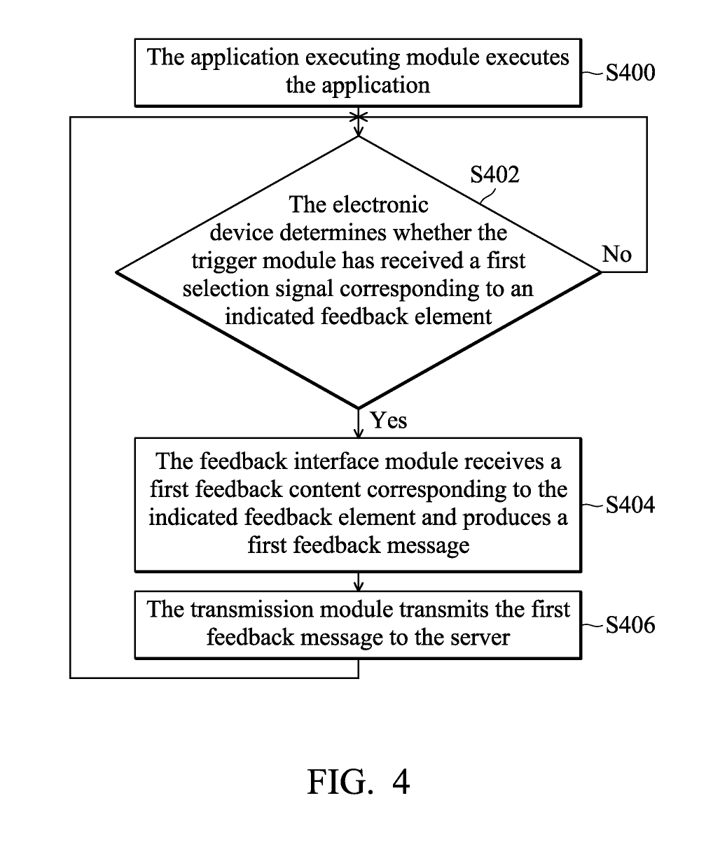

FIG. 4 is a flowchart of a feedback method according to an embodiment of the present invention. The feedback method is applied to the feedback system 100, the other processors or the other processing units which can execute the process and steps, wherein the feedback method is used to feedback comments for an application A1 which is being executed. The process starts at step S400.

In step S400, the application executing module 202 is used to execute the application A1 to display a plurality of display elements, wherein the application includes at least one of the display elements and at least one of a plurality of motion events provided for users to operate. More specifically, each of the display elements corresponds to a display element code, respectively. Each of the motion events corresponds to a motion event code, respectively. The display elements, the corresponding display element codes, the motion events, and the corresponding motion event codes can be recorded in a table or a file stored in the memory unit or hard disk of electronic device 200. For example, when one of the display elements displayed by the application A1 is selected, one of the motion events is to scale up the selected display element. Moreover, when the other one of the display elements displayed by the application A1 receives a switching instruction, one of the motion events is to change the display frame on the application A1. Furthermore, when another one of the display elements displayed by the application A1 receives an adjusting instruction, one of the motion events is to display adjusting interface. But it is not limited thereto. Each of the display elements can be set with a predetermined position and a color setting information corresponding to its display element code respectively. For example, the background of the application A1 can be one of the display elements. Moreover, the images shown in the application A1 is also one of the display elements, but it is not limited thereto.

Next, in step S402, the electronic device 200 is used to determine whether the trigger module 204 receives a first selection signal corresponding to an indicated feedback element when the application executing module 202 executes the application A1. It should be noted that the indicated feedback element is one of the display elements. Moreover, the first selection signal can indicate a motion event by the motion event code corresponding to the indicated feedback element by the display element code. When the trigger module 204 receives the first selection signal corresponding to an indicated feedback element, step S404 is performed. The electronic device 200 continuous to determine whether the trigger module 204 receives the first selection signal corresponding to an indicated feedback element when the trigger module 204 do not receive the first selection signal corresponding to an indicated feedback element.

In step S404, the feedback interface module 206 is used to receive a first feedback content corresponding to the indicated feedback element and generate a first feedback message FM11, wherein the first feedback content is an indicated motion event corresponding to the indicated feedback element, and the first feedback message FM11 includes the first feedback content and the first selection signal. In another embodiment, the motion event code corresponding to the motion event of the first selection signal is the motion event code corresponding to the last executed motion event, but it is not limited thereto. Moreover, in another embodiment of the present invention, the first feedback message FM11 can further include the identification code of the electronic device 200, but it is not limited thereto.

Next, in step S406, the transmission module 208 is used to transmit the first feedback message to the server 300. Next, step S402 is performed, wherein the electronic device 200 continuous to determine whether the trigger module 204 receives the first selection signal corresponding to the indicated feedback element. In some embodiments of the present invention, the feedback interface module 206 is further used to generate a feedback interface and display the feedback interface above the application interface of the application A1. Furthermore, the feedback interface module 206 can receive the first feedback content by the application interface and the feedback interface according to the first selection signal. The feedback interface module 206 is further used to provide a voice recording interface, a video recording interface, a text input interface, a drawing interface or a screenshot figure interface to generate the first feedback content according to the first selection signal. Namely, when the trigger module 204 receives the first selection signal, the feedback interface module 206 provides a voice recording interface, a video recording interface, a text input interface, a drawing interface or a screenshot figure interface to generate the first feedback content, but it is not limited thereto.

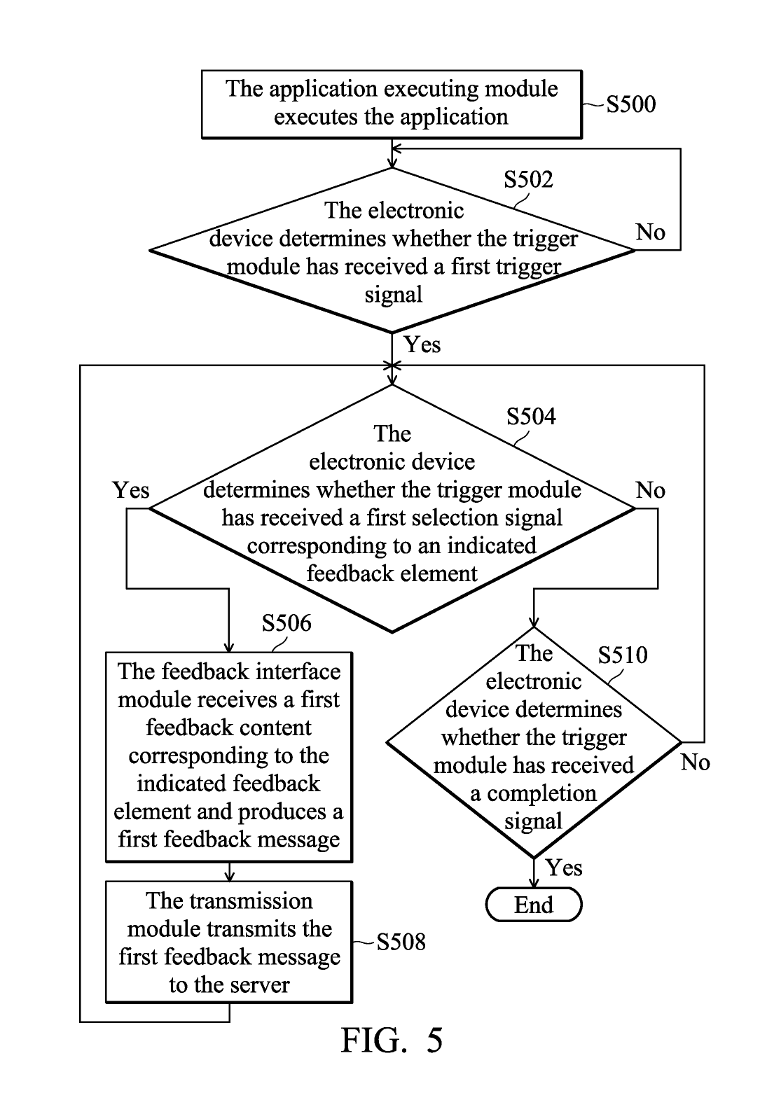

FIG. 5 is a flowchart of a feedback method according to another embodiment of the present invention. The feedback method is applied to the feedback system 100, the other processors or the other processing units which can execute the process and steps, wherein the feedback method is used to feedback comments for an application A1 which is being executed. The process starts at step S500.

In step S500, the application executing module 202 is used to execute the application A1 to display a plurality of display elements, wherein the application includes at least one of the display elements and at least one of a plurality of motion events provided for users to operate. More specifically, each of the display elements corresponds to a display element code, respectively. Each of the motion events corresponds to a motion event code, respectively. The display elements, the corresponding display element codes, the motion events, and the corresponding motion event codes can be recorded in a table or a file stored in the memory unit or hard disk of electronic device 200. For example, when one of the display elements displayed by the application A1 is selected, one of the motion events is to scale up the selected display element. Moreover, when the other one of the display elements displayed by the application A1 receives a switching instruction, one of the motion events is to change the display frame on the application A1. Furthermore, when another one of the display elements displayed by the application A1 receives an adjusting instruction, one of the motion events is to display adjusting interface. But it is not limited thereto. Each of the display elements can be set with a predetermined position and a color setting information corresponding to its display element code respectively, wherein the color setting information of the display elements is used to set the color of the display elements for display. For example, the background of the application A1 can be one of the display elements. Moreover, the images shown in the application A1 is also one of the display elements, but it is not limited thereto.

Next, in step S502, the electronic device 200 is used to determine whether the trigger module 204 receives a first trigger signal. When the trigger module 204 receives the first trigger signal, the electronic device 200 enters a first feedback period, and step S504 is performed, otherwise, the electronic device 200 continuous to determine whether the trigger module 204 receives a first trigger signal.

In step S504, the electronic device 200 is used to determine whether the trigger module 204 receives a first selection signal corresponding to an indicated feedback element in a first feedback period. It should be noted that the indicated feedback element is one of the display elements. Moreover, the first selection signal is the display element code and the motion event code which are used for indicating a motion event. When the trigger module 204 receives the first selection signal corresponding to an indicated feedback element, step S506 is performed. When the trigger module 204 does not receive the first selection signal corresponding to an indicated feedback element, step S510 is performed.

In step S506, the feedback interface module 206 is used to receive a first feedback content corresponding to the indicated feedback element and generate a first feedback message, wherein the first feedback content is an indicated motion event corresponding to the indicated feedback element, and the first feedback message includes the first feedback content and the first selection signal. In another embodiment, the motion event code corresponding to the motion event of the first selection signal is the motion event code corresponding to the last executed motion event, but it is not limited thereto. Moreover, in another embodiment of the present invention, the first feedback message can further include the identification code of the electronic device 200, but it is not limited thereto.

Next, in step S508, the transmission module 208 is used to transmit the first feedback message to the server 300. Next, step S504 is performed, wherein the electronic device 200 continuous to determine whether the trigger module 204 receives the first selection signal corresponding to the indicated feedback element.

In step S510, the electronic device 200 is used to determine whether the trigger module 204 receives a completion signal. When the trigger module 204 receives the completion signal, the first feedback period ends, and the process ends at step S510, otherwise, the process goes back to step S504, wherein the electronic device 200 continuous to determine whether the trigger module 204 receives a first selection signal corresponding to a motion event in the first feedback period. It should be noted that, in another embodiment of the present invention, step S508 may be deleted from the method of FIG. 5. For example, the feedback interface module 206 can store the first feedback message(s) FM11-FM1N generated in step S506 in a memory unit (not shown). The transmission module 208 can transmit the generated first feedback message(s) FM11-FM1N to the server 300, simultaneously, when the first feedback period ends (step S510). In some embodiments of the present invention, the feedback interface module 206 is further used to generate a feedback interface and display the feedback interface above the application interface of the application A1. Furthermore, the trigger module 204 can receive the first selection signal, the first trigger signal and the completion signal by the application interface and the feedback interface. The feedback interface module 206 can receive the first feedback content by the application interface and the feedback interface according to the first selection signal. The feedback interface module 206 is further used to provide a voice recording interface, a video recording interface, a text input interface, a drawing interface or a screenshot figure interface to generate the first feedback content and the second feedback content according to the first selection signal. Namely, when the trigger module 204 receives the first selection signal, the feedback interface module 206 provides a voice recording interface, a video recording interface, a text input interface, a drawing interface or a screenshot figure interface to generate the first feedback content, but it is not limited thereto.

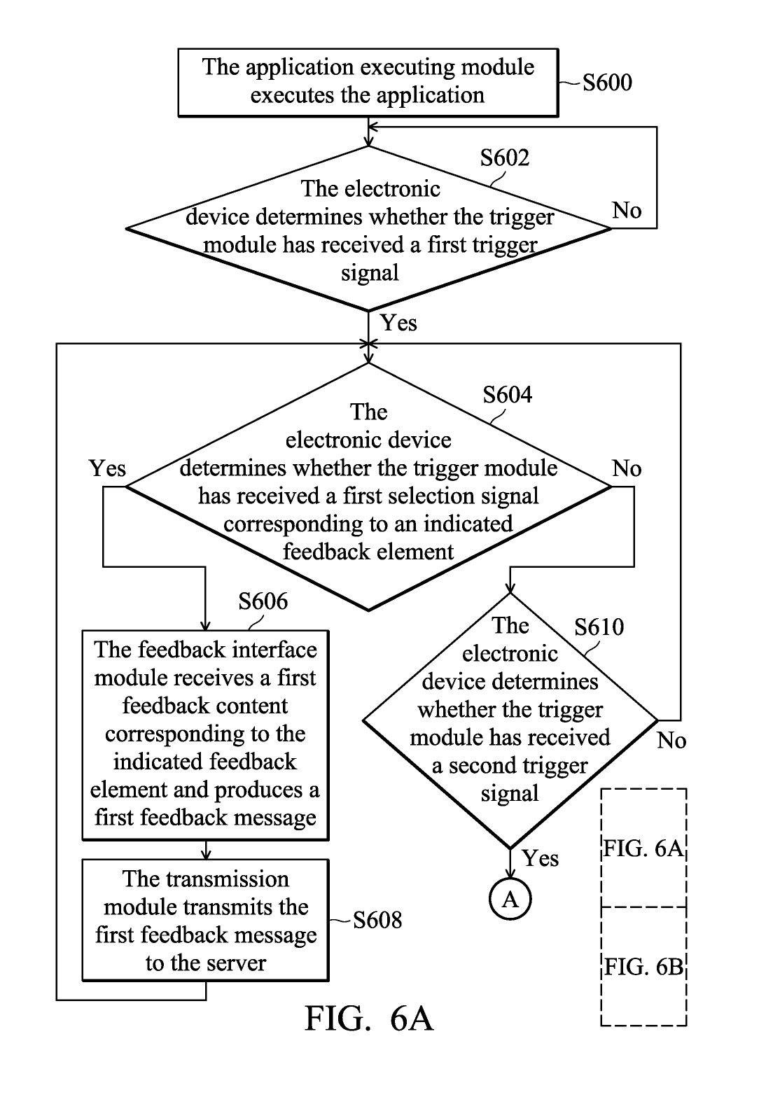

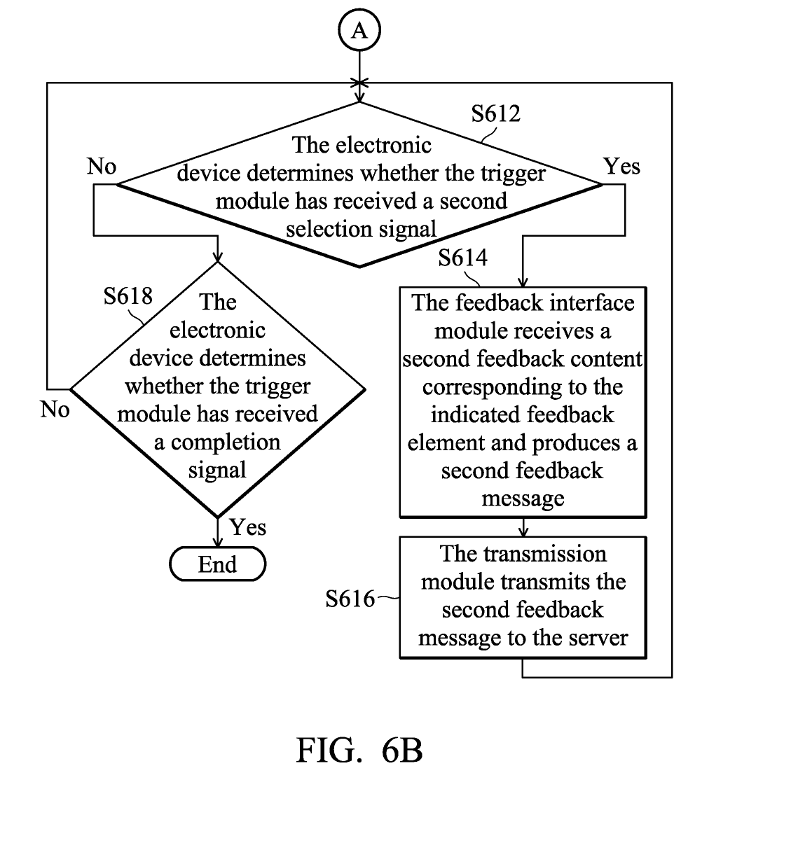

FIG. 6A-6B are a flowchart of a feedback method according to another embodiment of the present invention. The feedback method is applied to the feedback system 100, the other processors or the other processing units which can execute the process and steps, wherein the feedback method is used to feedback comments for an application A1 which is being executed. The process starts at step S600. It should be noted that steps S600-S608 are similar to steps S500-S508 in FIG. 5, and reference may be made to FIG. 5 for the detailed descriptions.

In step S610, the electronic device 200 is used to determine whether the trigger module 204 receives a second trigger signal. When the trigger module 204 receives the second trigger signal, the first feedback period ends, and the electronic device 200 enters a second first feedback period, and step S612 is performed, otherwise, step S604 is performed, and the electronic device 200 continuous to determine whether the trigger module 204 receives the first selection signal corresponding to the motion event in the first feedback period.

In step S612, the electronic device 200 is used to determine whether the trigger module 204 is in the second feedback period for receiving the second selection signal(s) corresponding to the display element(s). It should be noted that the indicated feedback element is one of the display element. Moreover, the second selection signal can be used as setting information corresponding to the indicated feedback element by the display element code, used for indicating a display element. When the trigger module 204 receives the second selection signal corresponding to an indicated feedback element, step S614 is performed. When the trigger module 204 does not receive the second selection signal corresponding to an indicated feedback element, step S618 is performed. For example, the background of the application A1 can be one of the display elements. Moreover, the images shown in the application A1 can also be one of the display elements, but it is not limited thereto.

In step S614, the feedback interface module 206 is used to receive a second feedback content corresponding to the indicated feedback element and generate a second feedback message, wherein the second feedback content is a display setting information corresponding to the indicated feedback element, and the second feedback message includes the second feedback content and the second selection signal. In another embodiment, the feedback interface module 206 is further used to receive a second feedback content of the indicated feedback element and integrate the second feedback content into the first feedback message FM11 when the trigger module 204 receives the second selection signal. Moreover, in another embodiment of the present invention, the second feedback message further includes the identification code of the electronic device 200, but it is not limited thereto.

Next, in step S616, the transmission module 208 transmits the second feedback message to the server 300. Next, the process goes back to step S612, wherein the electronic device 200 continuous to determine whether the trigger module 204 receives a second selection signal corresponding to the indicated feedback element.

In step S618, the electronic device 200 is used to determine whether the trigger module 204 receives a completion signal. When the trigger module 204 receives the completion signal, the second feedback period ends, and the process ends at step S618, otherwise, the process goes back to step S612, wherein the electronic device 200 continuous to determine whether the trigger module 204 receives a second selection signal corresponding to an indicated feedback element in the second feedback period. It should be noted that, in another embodiment of the present invention, steps S608 and S616 of FIG. 6 can be eliminated. For example, the feedback interface module 206 can store the first feedback message(s) FM11-FM1N and/or the second feedback message(s) FM21-FM2N which are generated in steps S606 and S614 in a memory unit (not shown). The transmission module 208 can transmit the first feedback message(s) FM11-FM1N generated in step S606 and/or the generated second feedback message(s) FM21-FM2N generated in step S614 to the server 300, simultaneously, when the second feedback period ends (step S618). In some embodiments of the present invention, the feedback interface module 206 is further used to generate a feedback interface and display the feedback interface above the application interface of the application A1. Furthermore, the trigger module 204 can receive the first trigger signal, the second trigger signal, the completion signal, the first selection signal and the second selection signal by the application interface. The feedback interface module 206 can receive the first feedback content or the second feedback content by the application interface and the feedback interface according to the first selection signal or the second selection signal. The feedback interface module 206 is further used to provide a voice recording interface, a video recording interface, a text input interface, a drawing interface or a screenshot figure interface to generate the first feedback content and the second feedback content according to the first selection signal or the second selection signal. Namely, when the trigger module 204 receives the first selection signal or the second selection signal, the feedback interface module 206 provides a voice recording interface, a video recording interface, a text input interface, a drawing interface or a screenshot figure interface to generate the first feedback content or the second feedback content, but it is not limited thereto.

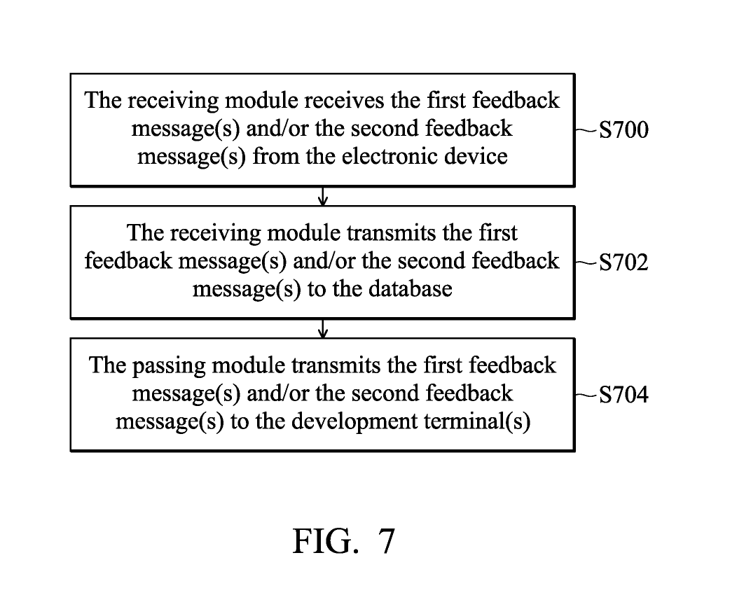

FIG. 7 is a flowchart of a feedback method according to another embodiment of the present invention after the process of FIGS. 4-6. The process starts at step S700. In step S700, the receiving module 302 is used to receive the first feedback message(s) FM1-FM1N and/or the second feedback message(s) FM21-FM2N from the electronic device 200. Next, in step S702, the receiving module 302 is used to transmit the first feedback message(s) FM1-FM1N and/or the second feedback message(s) FM21-FM2N to the database 304 for storing. Next, in step S704, the passing module 306 is used to transmit the first feedback message(s) FM1-FM1N and/or the second feedback message(s) FM21-FM2N to the development terminal(s) corresponding to the indicated feedback element according to the record table and the first feedback message(s) FM1-FM1N and/or the second feedback message(s) FM21-FM2N which correspond to the indicated feedback element. It should be noted that the server 300 includes a record module 308 used to store a record table, the received first feedback message(s) and the received second feedback message(s), and the passing module 306 is used to transmit the first feedback message(s) FM1-FM1N and/or the second feedback message(s) FM21-FM2N to the development terminal(s) corresponding to the indicated feedback element according to the record table. For example, each of the display elements corresponds to a display element code, and each of the motion events corresponds to a motion event code. Each of the development terminals corresponds to information of a developer, and the record table is used to record the relation of each of the display elements, each of the motion events, and the information of the corresponding developers. The passing module 306 is further used to retrieve the corresponding information of a developer corresponding to the display element code and the motion event code of the indicated feedback element from the record table and transmit the first feedback message or the second feedback message. Moreover, the record module 308 can divide the interface of the application A1 into a plurality of areas, and record each of the display elements and the display elements with the corresponding development terminals by tree data. In one of the embodiments of the present invention, the first feedback content is at least one of first instructions used for adjusting the motion of the motion event(s). The second feedback content is at least one of second instructions used for adjusting the predetermined position and the color setting information of the display element(s). The first development terminal and the second development terminal can adjust the application A1 according to the first instruction and the second instruction. In another embodiment of the present invention, the first feedback content includes at least one of first instructions used for adjusting the motion of the motion event(s). The second feedback content includes at least one of second instructions used for adjusting the predetermined position and the color setting information of the display element(s). In another embodiment, the server 300 further includes an application adjusting module (not shown) used to modify the corresponding indicated feedback element of the application A1 according to the first instruction and/or the second instruction to update the application A1.

The present invention further provides a recording media used to store a plurality of physical computer readable codes used for retrieval and execution by computers for a feedback method. The recording media includes a first program code, a second program code, a third program code, a fourth program code and a fifth program code. The first program code is used to execute an application A1 to display a plurality of display elements, wherein at least one of the display elements corresponds to at least one of a plurality of motion events provided for users to operate. The second program code is used to determine whether a first selection signal has been received when the application A1 is being executed. The third program code is used to receive a first feedback content corresponding to an indicated feedback element when the first selection signal has been received. The fourth program code is used to generate a first feedback message, wherein the first feedback message includes the first feedback content and the first selection signal. The fifth program code is used to transmit the first feedback message to a server 300.

The feedback system provided by the present invention provides users an interface to feedback motion events and the display elements and transmit the comments to the corresponding development terminal(s) according to a table.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A feedback system, used to feedback comments for an application when the application is being executed, comprising:
an application executing module, used to execute the application to display a plurality of display elements, wherein at least one of the display elements corresponds to at least one of a plurality of motion events provided for a user to operate;
a trigger module, used to receive a first selection signal when the application executing module executes the application, wherein the first selection signal corresponds to an indicated feedback element, and the indicated feedback element is one of the display elements;
a feedback interface module, used to receive a first feedback content corresponding to the indicated feedback element and generate a first feedback message when the trigger module receives the first selection signal, wherein the first feedback message comprises the first feedback content and the first selection signal; and
a transmission module, used to transmit the first feedback message to a server.

2. The feedback system as claimed in claim 1, wherein the first feedback content is an indicated motion event corresponding to the indicated feedback element, each of the display elements corresponds to a display element code respectively, each of the motion events corresponds to a motion event code respectively, and the first selection signal corresponds to the display element code of the indicated feedback element and the motion event code of the indicated motion event.

3. The feedback system as claimed in claim 2, wherein the trigger module is further used to receive a second selection signal when the application executing module executes the application, and the second selection signal is the display element code corresponding to the indicated feedback element, and the feedback interface module is further used to receive a second feedback content corresponding to the indicated feedback element, and the first feedback message further comprises the second feedback content, and the second feedback content is a display setting information corresponding to the indicated feedback element.

4. The feedback system as claimed in claim 1, wherein the trigger module is used to receive the first selection signal during a first feedback period, and the trigger module is further used to receive a first trigger signal and a completion signal, wherein the first feedback period starts when the trigger module receives the first trigger signal, and the first feedback period ends when the trigger module receives the completion signal.

5. The feedback system as claimed in claim 4, wherein the first feedback content is an indicated motion event corresponding to the indicated feedback element, and the trigger module is further used to receive a second selection signal corresponding to one of the display elements during a second feedback period, and the feedback interface module is further used to receive a second feedback content and generate a second feedback message when the trigger module receives the second selection signal during the second feedback period, and the second feedback content is a display setting information corresponding to the indicated feedback element, and the transmission module is further used to transmit the second feedback message to the server.

6. The feedback system as claimed in claim 1, wherein the application is displayed by an application interface to display the display elements, and the feedback interface module is further used to generate a feedback interface and display the feedback interface on the application interface, and the first selection signal and the first feedback content are received by the application interface and the feedback interface.

7. The feedback system as claimed in claim 3, further comprising the server, wherein the server comprises:
a database, used to store a record table and the first feedback message, wherein the record table is used to store a plurality of development terminals corresponding to the display elements or the motion events;
a receiving module, used to receive the first feedback message and transmit the first feedback message to the database to store; and
a passing module, used to transmit the first feedback message to a first development terminal corresponding to the indicated feedback element according to the indicated feedback element and data of the record table which are indicated by the first feedback message.

8. The feedback system as claimed in claim 7, wherein each of the display elements corresponds to a display element code, each of the motion events corresponds to a motion event code respectively, each of the development terminals corresponds to information of a developer respectively, and the record table is used to record the information of developers corresponding to the display element codes and the motion event codes, and the passing module is used to retrieve the information of a developer corresponding to the display element code and the motion event code of the indicated feedback element from the record table, and transmit the first feedback message, accordingly.

9. The feedback system as claimed in claim 1, wherein the first feedback content comprises at least one first instruction used for modifying the indicated feedback element, and, wherein the server further comprises an application adjusting module used to modify the indicated feedback element of the application according to the first instruction to update the application.

10. A feedback method, applied to a feedback system and used to feedback comments foe an application when the application is being executed, comprising:
executing the application to display a plurality of display elements, wherein at least one of the display elements corresponds to at least one of a plurality of motion events provided for users to operate;
determining whether a first selection signal has been received when the application is being executed;
receiving a first feedback content corresponding to an indicated feedback element when the first selection signal has been received, wherein the indicated feedback element is one of the display elements;
generating a first feedback message, wherein the first feedback message comprises the first feedback content and the first selection signal; and
transmitting the first feedback message to a server.

11. The feedback method as claimed in claim 10, wherein the first feedback content is an indicated motion event corresponding to the indicated feedback element, each of the display elements corresponds to a display element code respectively, each of the motion events corresponds to a motion event code respectively, and the first selection signal corresponds to the display element code of the indicated feedback element and the motion event code of the indicated motion event.

12. The feedback method as claimed in claim 11, further comprising:
determining whether a second selection signal has been received when the application is being executed, wherein the second selection signal is the display element code corresponding to the indicated feedback element; and
receiving a second feedback content corresponding to the indicated feedback element when the second selection signal has been received, wherein the first feedback message further comprises the second feedback content, and the second feedback content is a display setting information corresponding to the indicated feedback element.

13. The feedback method as claimed in claim 10, further comprising:
determining whether a first trigger signal has been received;
starting a first feedback period when the first trigger signal has been received, wherein the step of determining whether the first trigger signal has been received is executed during the first feedback period;
determining whether a completion signal has been received during the first feedback period; and
ending the first feedback period when the completion signal has been received.

14. The feedback method as claimed in claim 13, further comprising:
determining whether a first trigger signal has been received;
starting the first feedback period when the first trigger signal has been received;
determining whether a second trigger signal has been received during the first feedback period;
ending the first feedback period and starting the second feedback period when the second trigger signal has been received;
determining whether a completion signal has been received during the second feedback period; and
ending the second feedback period when the completion signal has been received, wherein the first feedback content is an indicated motion event corresponding to the indicated feedback element, and the second feedback content is a display setting information corresponding to the indicated feedback element.

15. The feedback method as claimed in claim 10, wherein the application is displayed by an application interface to display the display elements, and the steps of receiving the first selection signal and the second selection signal further comprise:
generating a feedback interface and displaying the feedback interface on the application interface; and
receiving the first selection signal and the first feedback content by the application interface and the feedback interface.

16. The feedback method as claimed in claim 12, further comprising:
receiving the first feedback message by the server;
storing the first feedback message in a database; and
transmitting the first feedback message to a first development terminal according to the indicated feedback element and data of the record table which are indicated by the first feedback message.

17. The feedback method as claimed in claim 16, wherein the step of transmitting the first feedback message to the first development terminal further comprises retrieving the information of a developer corresponding to the display element code and the motion event code of the indicated feedback element from the record table and transmitting the first feedback message, accordingly, wherein each of the display elements corresponds to a display element code respectively, each of the motion events corresponds to a motion event code respectively, each of the development terminals corresponds to information of a developer, and the record table is used to record the information of developers corresponding to the display element codes and the motion event codes.

18. The feedback method as claimed in claim 10, wherein the first feedback content comprises at least one first instruction used for modifying the indicated feedback element, and, wherein the server further comprises an application adjusting module used to modify the indicated feedback element of the application according to the first instruction to update the application.

19. A recording media, used to store a plurality of physical computer readable codes used for retrieval and execution by computers for a feedback method, comprising:
a first program code, used to execute an application to display a plurality of display elements, wherein at least one of the display elements corresponds to at least one of a plurality of motion events provided for users to operate;
a second program code, used to determine whether a first selection signal has been received when the application is being executed;
a third program code, used to receive a first feedback content corresponding to an indicated feedback element when the first selection signal has been received, wherein the indicated feedback element is one of the display elements;
a fourth program code, used to generate a first feedback message, wherein the first feedback message comprises the first feedback content and the first selection signal; and
a fifth program code, used to transmit the first feedback message to a server.
